(19) United States
(12) Patent Application Publication
(10) Pub. No.: US 2026/0074600 A1
(43) Pub. Date: Mar. 12, 2026

(54) Superconducting Motor with Truss-Supported Multilayer Insulation

(71) Applicant: Hinetics, Inc., Champaign, IL (US)

(72) Inventors: Samith Sirimanna, Urbana, IL (US); Brian Roland, Jamestown, ND (US); Kiruba S. Haran, Champaign, IL (US)

(21) Appl. No.: 19/320,624

(22) Filed: Sep. 5, 2025

Related U.S. Application Data
(60) Provisional application No. 63/692,971, filed on Sep. 10, 2024.

(51) Int. Cl. H02K 55/04; H02K 9/22

(52) U.S. Cl. CPC H02K 55/04; H02K 9/223

(57) ABSTRACT

A lightweight, multilayer cryogenic insulator is formed by successive layers of low-emissivity sheeting and a separating truss-structure operating to resist circumferential deflection of the low-emissivity sheeting.

### CROSS REFERENCE TO RELATED APPLICATION

This application claims the benefit of U.S. provisional application 63/692,971 filed Sep. 10, 2024, and hereby incorporated by reference.

### BACKGROUND OF THE INVENTION

The present invention relates to high power-to-weight electric machines for aerospace applications and the like, and in particular to a superconducting electric motor having an improved multilayered insulator (MLI) for preserving cryogenic temperatures at high speed.

Electric motors for aerospace applications, for example, for use in aircraft, must provide a high specific power, that is high-power output with light weight. Currently produced wound-field synchronous motors can provide about two kilowatts of power per kilogram of weight with a nominal efficiency of about 90 percent. Recent advances using permanent magnets have achieved specific power in excess of 13 kilowatts per kilogram with efficiencies in excess of 96 percent; however, the fault tolerance of such permanent magnet systems has not been established.

Desirably, the permanent magnets of such electric motors could be replaced with superconducting coils to provide improved efficiency and lighter weight (greater specific power). The substantial demands of cryogenic cooling sufficient to cool such motors, however, present a significant challenge because of the weight, complexity, and bulk of such coolers and the necessary plumbing for fluids used for heat transfer between the motor and the cooler.

US Patent publications US 2022/0302816 and 2024/0014709, assigned to the assignee of the present application and hereby incorporated by reference, describe construction techniques for cryogenic electrical motors employing a spoke system for suspending the superconducting rotor magnets about the shaft while providing low thermal conduction between the shaft and the rotor magnets. This spoke system reduces conductive heat transfer to the superconducting windings, improving cooling efficiency.

### SUMMARY OF THE INVENTION

The present invention provides a multilayer insulation (MLI), further reducing the heat passing to the superconducting coils but from radiative transfer rather than direct conduction. The multilayer insulation is constructed of multiple low-emissivity surfaces separated by a truss-structure which provides light weight and low thermal conductance between the layers because of its open mesh and truss-form while supporting the low-emissivity material against high centrifugal forces that might cause it to collapse together into thermal conduction.

More specifically, in one embodiment the invention provides a superconducting machine having a stator and a rotor with a central shaft rotatably mounted with respect to the stator to allow the rotor to rotate about a shaft axis with respect to a stator. The rotor includes a set of superconducting windings positioned on the rotor shell and a heatshield surrounding the superconducting windings formed of multiple alternate layers of a low-emissivity sheet material and a separating structure. The separating structure provides integrally connected circumferential top chords and circumferential bottom chords; the latter radially spaced from the circumferential top chords and interconnected to the top chords by radially extending webs to provide a circumferential truss-structure.

It is thus a feature of at least one embodiment of the invention to provide a self-supporting MLI that can resist high centrifugal forces while maintaining low weight and low thermal conductivity through a combination of a low emissivity sheet material and truss-structure.

The separating structure may further include axial top chords and axial bottom chords, the latter radially spaced from the axial top chords and interconnected to the top chords by the radially extending webs to provide an axial truss-structure.

It is thus a feature of at least one embodiment of the invention to make use of the webs to produce a two-dimensional truss offering better support of the low-emissivity sheet material.

The axial chords and circumferential chords may be aligned in upper and lower respective meshes each providing rectangular mesh elements with sides aligned with axial and circumferential directions.

It is thus a feature of at least one embodiment of the invention to optimize the orientation of the circumferential chords to resist hoop stresses and the support of the sheetlike material with minimal truss weight.

In one embodiment, the webs of the separating structures among the multiple alternate layers may be radially aligned.

It is thus a feature of at least one embodiment of the invention to provide improved resistance to hoop stresses by transmitting forces between the layers through aligned compressive web elements.

Alternatively, the webs of the separating structures among the multiple alternate layers maybe radially staggered.

It is thus a feature of at least one embodiment of the invention to increase thermal path length between the layers thus reducing interlayer thermal conduction.

The webs may have a progressively increasing cross section along the circumferential dimension in the multiple layers of separating structure as one moves radially outward through the heatshield.

It is thus a feature of at least one embodiment of the invention to effect an improved trade-off between resisting centrifugal force and weight/thermal conductivity by tailoring the web cross-sections according to radial position.

These particular objects and advantages may apply to only some embodiments falling within the claims and thus do not define the scope of the invention.

### BRIEF DESCRIPTION OF THE DRAWINGS

FIG. 1 is a simplified exploded view of the principal components of a motor constructed according to the present invention including a stator and a concentrically rotating wound-field rotor within a vacuum envelope showing the MLI around the rotor coils;

FIG. 2 is a fragmentary cutaway perspective view of the MLI showing low-emissivity sheets separated by a truss-structure made up of successive truss mesh elements;

FIG. 3 is a cross-sectional view of the end of the truss-structure of FIG. 3 showing alignment of the truss webs;

FIG. 4 is a set of fragmentary cross-sectional views of truss webs as one moves outward through the MLI;

FIG. 5 is a figure similar to FIG. 2 showing a staggering of the truss elements in the second embodiment; and

FIG. 6 is a figure similar to FIG. 3 showing operation of the staggering to reduce potential contact between successive layers of the flexible sheet material.

### DETAILED DESCRIPTION OF THE PREFERRED EMBODIMENT

### Motor Overview

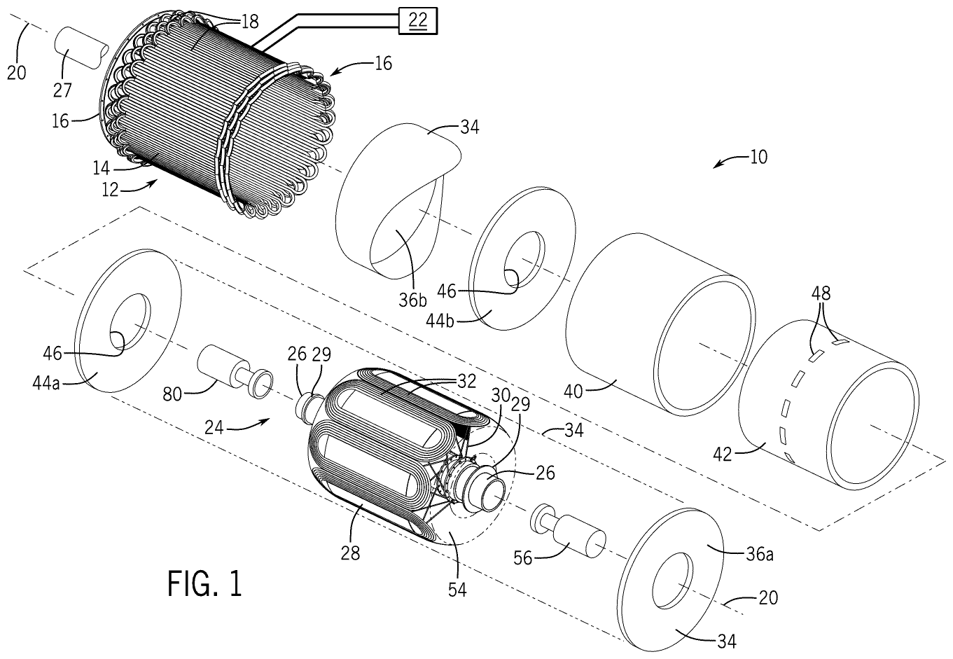

Referring now to FIG. 1, a superconducting motor 10 per the present invention may include a stator 12 providing, in one embodiment, a generally cylindrical, tubular stator form 14 having an outwardly flared end 16. A set of stator coils 18 may be attached to an inner surface of the stator form 14 spaced angularly about an axis 20 of the stator form 14 and extending between its opposite ends to provide a radially directed magnetic axis. The stator coils 18 may be air-core coils stabilized in a potting material as attached to the stator form 14 and may communicate with a motor drive circuit 22, for example, sequentially energizing the stator coils 18 to create a rotating magnetic field about the axis 20 as is generally understood in the art.

Fitting within the stator form 14 to rotate therein about the axis 20 is a rotor 24 providing a tubular rotor shaft 26 that may communicate beyond the confines of the motor 10 as a driveshaft 27 connected, for example, to turbine or propeller systems of aircraft or the like (not shown). The rotor shaft 26 may be supported for rotation on bearings generally understood in the art.

A rotor shell 28 is positioned concentrically around the shaft 26 and held for co-rotation with the shaft 26 by a set of thermally insulated spokes 30 radiating outwardly from the shaft 26. The shell 28 may be constructed of aluminum, or other lightweight material, to have low weight and low moment of inertia and will typically have a radial thickness of less than 100th of the radius of the shell 28 from the axis 20.

An outer surface of the rotor shell 28 includes a set of rotor coils 32 having an elongate racetrack shape and, more specifically, following the shape of a geometric stadium being a rectangle with semicircles at opposite ends, with a longest dimension extending between axial ends of the rotor shell 28. The rotor coils 32 will be spaced circumferentially around the rotor shell 28 and centered within the faces 29 at equal angular intervals and may be air-core planar coils, the latter term, as used herein, meaning that the coils are substantially two-dimensional being wound helically in one or a limited number of layers to conform to a surface. Generally, the rotor coils 32 will be high-temperature superconductive materials so as sustain a strong magnetic field without significant power consumption in the manner of a permanent magnet but with much lower mass and, hence, weight. Generally the rotor coils 32 may be infused with a stabilizing polymer or epoxy material.

As so mounted, the rotor coils 32 may be substantially constrained to a single plane allowing bending of the conductors of the rotor coils but reduced twisting.

The outer surface of the rotor coils 32 may be covered with a multilayer insulator 31 as will be described in greater detail below.

Referring still to FIG. 1, a cylindrical vacuum envelope 34 closely surrounds the stator shell 28 and includes end caps 36a and 36b providing bases to the cylinder and sealing the ends of the vacuum envelope 34 against the outer circumference of the shaft 26 to provide an airtight volume 38 that may be evacuated to reduce convective heat loss between the shell 28 and outside structures of the motor and between the shell 28 and the shaft 26. End cap 36b may have a radially outwardly extending impeller 41 pulling air, as indicated by airflow 42, over the outer surface of the stator form 14 for cooling of the same as the rotor 24 rotates.

Positioned on either side of end cap 36a are wireless transmission coils 50a and 50b forming primary and secondary windings of a transformer for transferring power through the vacuum envelope 34 without breach thereof to provide excitation power to the rotor coils 32. Coil 50 may be energized by a high-frequency power source 52, and coil 50b may communicate with the rotor coils 32 by means of a power conditioner 54 providing solid-state rectification and filtering of the alternating current transferred between the transmission coils 50a and 50b to produce the necessary DC voltages for the rotor coils 32. Other systems for wirelessly providing current to the coils 32 include contactless flux pumps of a type known in the art.

Referring still to FIG. 1, in one of multiple embodiments, a cryocooler 56 may extend along the axis 20 and have a cold end 58 passing into the hollow tubular shaft 26 to be roughly centered within the ends of the rotor 24 and attached to the shaft 26 by insulating supports to rotate therewith. A hot end 60 of the cryocooler 56 may extend outside of the vacuum envelope 34 to receive power to drive a sterling cycle heat pump pumping heat from the cold end 58 to the hot end 60 (at ambient temperatures) to bring the temperature of the cold end 58 to cryogenic temperatures of less than 50°Kelvin. Cryocoolers 56 suitable for use with the present invention are commercially available, for example, from the Sunpower Division of AMTEK of Berwyn, Pennsylvania, under the trade name CryoTel GT.

### Multilayer Insulator

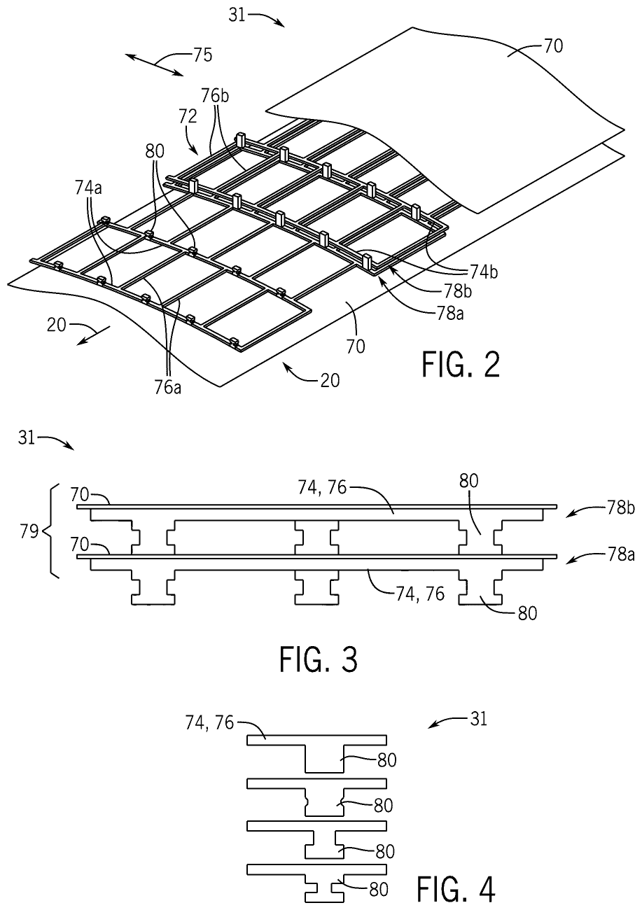

Referring now to FIG. 2, the multilayer insulator (MLI) 31 may comprise alternating layers of a thin low-emissivity sheet 70 and a truss-structure separator 72, the latter providing a thermal barrier between successive low-emissivity sheets 70 in the MLI 31.

The low-emissivity sheets 70, for example, may each be a thin polymer material, typically less than 0.005 inches in thickness, and may be metallized, for example, by vacuum metallization on its opposing surface. Example polymer material for the low-emissivity sheets 70 include Kapton™, Mylar™, or Teflon, being trade names for polyimide, biaxially-oriented polyethylene terephthalate, and polytetrafluoroethylene, respectively, or other similar material. This metal may be, for example, aluminum or other low-emissivity metal such as gold or the like.

The truss-structure separator 72 is desirably constructed of a set of inner circumferential chords 74a extending generally along a circumferential direction 75 interconnected with a set of axial chords 76a extending generally parallel to the axis 20. The inner circumferential chords 74a and inner axial chords 76a may be arranged to form a rectilinear and generally coplanar mesh 78a following the slight curvature of the rotor 24 and providing an open area averaging greater than 5% or greater than 10% to reduce conductive heat transfer through the resulting truss-structure separator 72.

Positioned radially outward from the inner circumferential chords 74a and inner axial chords 76a is a similar set of a outer circumferential chords 74b extending generally along a circumferential direction 75 and outer axial chords 76b extending generally parallel to the axis 20. The outer circumferential chords 74b and outer axial chords 76b again form a rectilinear and generally coplanar mesh 78b following the slight curvature of the rotor 24 and providing an open area averaging greater than 5% and in some cases greater than 10% to reduce conductive heat transfer through the resulting truss-structure 72.

The mesh 78a and mesh 78b are held at a radially spaced separation of, for example, greater than 0.1 mm and less than 1 mm by a set of web standoffs 80 spaced along the circumferential chords 74 and integrally connected between the outer circumferential chords 74b and the inner circumferential chords 74b. In some cases, the web standoffs 80 may be positioned at the intersections of the circumferential chords and 74 and axial chords 76. As depicted, however, the location of the web standoffs 80 and the intersections of the circumferential chords 74 and axial chords 76 may be staggered so as to increase a length of material (and hence thermal resistance) through which heat must be conducted in order to pass from a first low-emissivity sheet 70 into the mesh 78a, through a web standoff 80, and to the mesh 78b then to a second low-emissivity sheet 70 by promoting a serpentine path.

Referring now to FIG. 3, the structure shown in FIG. 2 may be duplicated to create multiple radially stacked layers 79 of successive low-emissivity sheets 70 and truss-structure separators 72 in which successive layers share a low-emissivity sheet 70 and mesh 78. For example, the outer chords 74 and 76 of an inner layer 79 may provide the inner chords 74 and 76 of the next succeeding layer 79. The number of layers 79 may, for example, be greater than 10 and may have a thickness of less than 1 cm.

As will be understood in the art, the web standoffs 80 of each layer 79 are fixedly attached to the chords 74 and 76 at their inner and outer edge, for example, by adhesive attachment through the low-emissivity sheet 70 to an inner mesh 78 and through 3-D printing, molding, or the like. Likewise the low-emissivity sheet 70 may be adhesively attached to a respective mesh 78 over the length of the chords 74 and 76.

It will be understood that the attachment of the outer mesh 78 to the inner mesh 78 through the web standoffs 80 provides an effective truss-structure where bending forces acting on the layer 79 are converted to tensile and compressive forces along the various chords 74 and 76. Preferably both axial trusses and circumferential trusses are created in this manner. The truss-structure allows the support of the low-emissivity sheet 70 to be light weight while resisting the centrifugal forces on the low-emissivity sheet 70. In some embodiments the truss-structures will have a radial thickness of less than 0.5 mm. It will be appreciated generally that the chords 74 and 76 themselves may be formed of smaller trusses for similar effect.

The circumferential chords 74 may desirably be formed of a material with a high elastic modulus to resist hoop stresses caused by rapid rotation of the MLI 31. The truss-structure separator 72 in this case will desirably be a material with an elastic modulus of at least 10 and desirably at least 20 times that of the elastic modulus of the low-emissivity sheet 70. More specifically, the truss-structure separator 72 may have an elastic modulus of at least 50 GPa. Suitable materials include but are not limited to Kevlar™ (para-aramid fibers), glass fiber, and carbon fiber. These fibers may be wound in place, for example, as a prepreg or printed using a thermoplastic embedded with chopped fibers.

The axial chords 76 do not experience hoop stresses and accordingly can have a lower elastic modulus requiring only sufficient strength to preserve their truss-structure rigidity. In this respect, the axial chords 76 may be constructed of a different material having a lower elastic modulus or may provide for a lower linear density of material (measured circumferentially) compared to the linear density of the circumferential chords 74 (measured radially).

More generally, the linear density of circumferential chords 74 along the shaft axis 20 may be higher than the linear density of axial cords 76 circumferentially to the shaft axis 20 by at least 20% and, in some cases, greater than 40%.

Referring now to FIG. 4, generally successive outer layers 79 of the MLI 31 will experience increased outward radial force caused by their support of an increasing number of inner layers 79 against expansion under centrifugal force. For that reason, the minimal or average cross-sectional area of the web standoffs 80 measured circumferentially may increase to provide greater compressive strength as one moves radially outward through the layers 79. By tailoring the cross-section of the material, weight and thermal conductivity may be minimized while providing adequate structural strength.

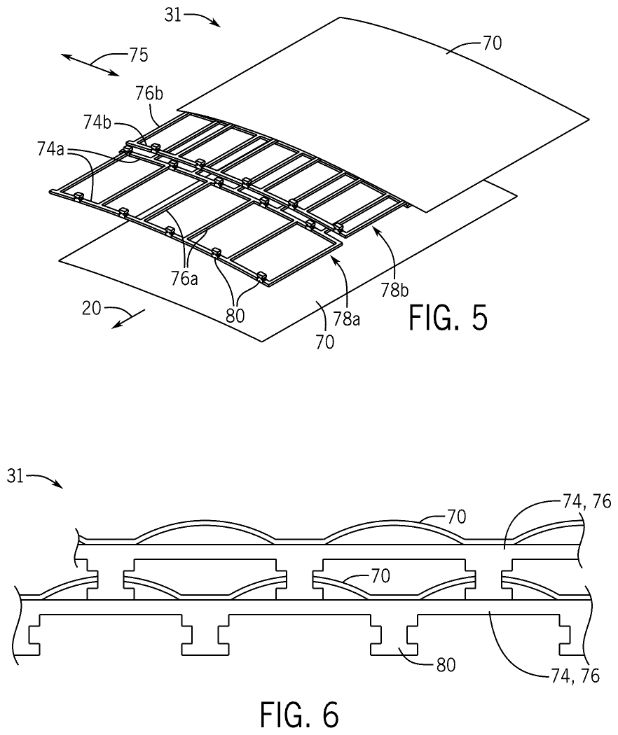

Referring now to FIGS. 5 and 6, the spacing between the low-emissivity sheet 70 provided by the interposition of the web standoffs 80 will be selected so that, under the centrifugal force experienced by the low-emissivity sheet 70, successive layers of the low-emissivity sheet 70 aligned with and separated at the openings of the truss-structure separator 72 will not touch as they flex under these forces. While the low-emissivity sheets 70 may be attached to the chords 74 and 76 adhesively minimizing flexure, the center portions of the low-emissivity sheet 70 within the opening formed by the mesh of chords 74 and 76 may flex by a greater extent possibly as depicted in FIG. 6 creating a path of contact and thermal conduction between the low-emissivity sheets 70 of subsequent layers. This can be further reduced by a staggering of the web standoffs 80 in successive layers so that they do not align in radial directions. The staggering can also increase the path that heat needs to travel between the layers thus reducing thermal conductivity. In other respects the structures of FIGS. 5 and 6 may be as described with respect to FIGS. 2, 3, and 4.

The truss-structure separator 72 and the low-emissivity sheet 70 may be flexible to easily wrap around the rotor 24 or may be printed in place. The layers may be concentric circular layers or may be a helical wrapped layer.

The open structure of the truss-structure separator 72 allows the free passage of gas out of the spaces of the truss-structure separator 72 when the material is placed within the vacuum of the vacuum envelope 34.

While the above description is generally focused on the construction of a motor, it will be appreciated that the same principles will produce an electrical generator and thus the invention generally involves an electrical machine rather than a motor or generator particularly.

Additional features of the superconducting motor are described in US patent applications: 20220360129; 20220302816; 20240014709; 20230082739; and U.S. Pat. No. 12,068,669, all assigned to the assignee of the present invention and hereby incorporated by reference.

Certain terminology is used herein for purposes of reference only and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S. C. 112(f) unless the words “means for” or “step for” are explicitly used in the particular claim.

What we claim is:

1. A superconducting machine comprising:
a stator; and
a rotor having an axially extending central shaft rotatably mounted with respect to the stator to allow the rotor to rotate about a shaft axis with respect to a stator, wherein the rotor includes:
a set of superconducting windings positioned on the rotor shell; and
a heatshield circumferentially surrounding the superconducting windings and formed of multiple alternate layers of a low-emissivity sheet material and separating structure, the separating structure providing integrally connected circumferential top chords and circumferential bottom chords, the latter radially spaced from the circumferential top chords and interconnected to the circumferential top chords by radially extending webs to provide a set of interconnected circumferential trusses.

2. The superconducting machine of claim 1 wherein the separating structure further includes axial top chords and axial bottom chords, the latter radially spaced from the axial top chords and interconnected to the top chords by the radially extending webs to provide an axial truss-structure.

3. The superconducting machine of claim 2 wherein the axial top chords and circumferential top chords are aligned in a top mesh, and the axial top chords and circumferential bottom chords are aligned in a bottom mesh, each mesh each having rectangular mesh elements with sides aligned with axial and circumferential directions.

4. The superconducting machine of claim 2 wherein a combined elastic modulus to axial forces provided by the axial top chords and axial bottom chords is lower than a total combined elastic modulus to circumferential forces provided by the circumferential top chords and circumferential bottom chords.

5. The superconducting machine of claim 1 wherein the low-emissivity sheet material is a flexible sheet of metallized polymer and wherein a material of the top circumferential chords and bottom circumferential chords has an elastic modulus at least 10 times a material of the low-emissivity sheet material.

6. The superconducting machine of claim 5 wherein top circumferential chords and bottom circumferential chords are composite thermoplastic fiber materials including fibers having an elastic modulus of greater than 50 GPa.

7. The superconducting machine of claim 6 wherein the fibers are selected from the group consisting of para-aramid fibers, carbon fiber, and glass fiber.

8. The superconducting machine of claim 1 wherein the webs of the separating structures among the multiple alternate layers are radially aligned.

9. The superconducting machine of claim 1 wherein the webs of the separating structures among the multiple alternate layers are radially staggered.

10. The superconducting machine of claim 1 wherein the webs have a progressively increasing cross section along the circumferential dimension in the multiple layers of separating structure as one moves radially outward through the heatshield.

11. The superconducting machine of claim 1 wherein the low emissivity sheet material is a flexible sheet of metallized polymer selected from the group of polyimide, biaxially-oriented polyethylene terephthalate, and polytetrafluoroethylene.

12. The superconducting machine of claim 1 wherein the low-emissivity sheet material has a thickness of less than 0.005 inches.

13. The superconducting machine of claim 1 wherein the low-emissivity sheet material is aluminized on both of opposite sides of the sheet.

14. The superconducting machine of claim 1 wherein a number of alternate layers is greater than 10.

15. The superconducting machine of claim 1 wherein chords have a radial thickness of less than 0.5 mm.

16. The superconducting machine of claim 1 wherein top chords and bottom chords are radially spaced by at least 0.1 mm and less than 1 mm.

17. The superconducting machine of claim 1 wherein the supporting structure has at least 5% open area measured circumferentially.

18. The superconducting machine of claim 1 wherein a total thickness of the multiple alternate layers is less than 1 cm.

19. The superconducting machine of claim 1 wherein the low-emissivity sheet material is attached by adhesive to at least one of the circumferential top chords and one of the circumferential bottom chords.
